(19) United States
(12) Patent Application Publication
(10) Pub. No.: US 2025/0077772 A1
(43) Pub. Date: Mar. 6, 2025

(54) INFORMATION PROCESSING APPARATUS AND NON-TRANSITORY RECORDING MEDIUM

(71) Applicants: Yuuki Suzuki, Kanagawa (JP); Jun Nakagawa, Kanagawa (JP)

(72) Inventors: Yuuki Suzuki, Kanagawa (JP); Jun Nakagawa, Kanagawa (JP)

(73) Assignee: Ricoh Company, Ltd., Tokyo (JP)

(21) Appl. No.: 18/816,240

(22) Filed: Aug. 27, 2024

(30) Foreign Application Priority Data
Sep. 1, 2023 (JP) 2023-141904

(51) Int. Cl. G06F 40/279; G10L 15/01

(52) U.S. Cl. CPC G06F 40/279; G10L 15/01

(57) ABSTRACT

An information processing apparatus includes circuitry to display, on a display, an evaluation item indicating an evaluation of a comment of a user in association with a character string of the comment.

### CROSS-REFERENCE TO RELATED APPLICATIONS

This patent application is based on and claims priority pursuant to 35 U.S.C. § 119 (a) to Japanese Patent Application No. 2023-141904, filed on Sep. 1, 2023, in the Japan Patent Office, the entire disclosure of which is hereby incorporated by reference herein.

### BACKGROUND

### Technical Field

The present disclosure relates to an information processing apparatus for evaluating communication and a non-transitory recording medium.

### Related Art

In a computer system for assisting communication between two users including a first user and second user, a processor includes a receiving unit that receives at least one topic that the first user wants to talk about in the communication and a response of the second user that is expected by the first user in the communication on the topic. In the computer system, the processor further includes a providing unit that provides advice in the communication to the second user based on the at least one topic and the response.

### SUMMARY

According to an aspect of the present disclosure, an information processing apparatus includes circuitry to display, on a display, an evaluation item indicating an evaluation of a comment of a user in association with a character string of the comment.

According to an aspect of the present disclosure, an information processing apparatus includes circuitry to generate a display screen to be displayed on a display, the display screen including an evaluation item indicating an evaluation of a comment of a user in association with a character string of the comment.

According to an aspect of the present disclosure, a non-transitory recording medium storing a plurality of instructions which, when executed by one or more processors, causes the processors to perform a method. The method includes displaying, on a display, an evaluation item indicating an evaluation of a comment of a user in association with a character string of the comment.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of the overall configuration of an information processing apparatus according to an embodiment;

FIG. 2 is a block diagram illustrating an example of a hardware configuration of each of an information analysis apparatus and a terminal apparatus according to an embodiment;

FIG. 3 is a block diagram illustrating an example of a functional configuration of an information processing apparatus according to an embodiment;

FIG. 4 is a sequence diagram illustrating an example of a process performed by an information processing apparatus according to an embodiment;

FIG. 5 is a sequence diagram illustrating an example of a process performed by an information processing apparatus according to an embodiment;

FIG. 6 is a diagram illustrating an example of a table included in an evaluation result database (DB) according to an embodiment;

FIG. 7 is a diagram illustrating another example of a table included in an evaluation result DB according to an embodiment;

FIG. 8 is a diagram illustrating an example of a display screen according to an embodiment;

FIG. 9 is a diagram illustrating an example of evaluation indicators and icons according to an embodiment;

FIG. 10 is a diagram illustrating a variation of a display screen (including highlighted character string);

FIG. 11 is a sequence diagram illustrating an example of a process performed by an information processing apparatus according to an embodiment;

FIG. 12 is a diagram illustrating an example of a table included in a model example DB according to an embodiment;

FIG. 13 is a diagram illustrating a variation of a display screen (playing a video);

FIG. 14 is a diagram illustrating a variation of a display screen (including highlighted character string);

FIG. 15 is a diagram illustrating a variation of a display screen (playing a model example);

FIG. 16 is a diagram illustrating a variation of a display screen (including a situation of a counterpart); and

FIG. 17 is a sequence diagram illustrating an example of a process performed by an information processing apparatus according to an embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the attached drawings. In the description of the drawings, the same components are denoted by the same reference signs, and redundant descriptions thereof are omitted.

### First Embodiment

### Overall Configuration of Information Processing Apparatus (System)

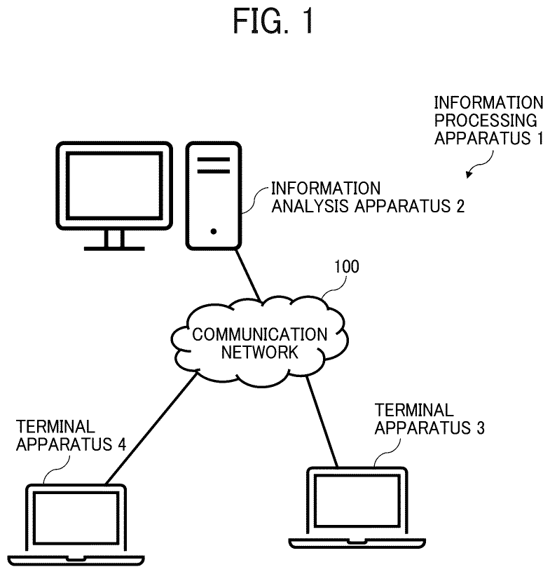

FIG. 1 is a diagram illustrating an example of the overall configuration of an information processing apparatus (information processing system) 1. As illustrated in FIG. 1, the information processing apparatus 1 includes apparatuses and terminals including an information analysis apparatus 2, a terminal apparatus 3, and a terminal apparatus 4. As illustrated in FIG. 1, the information analysis apparatus 2, the terminal apparatus 3, and the terminal apparatus 4 are communicably connected to each other through a communication network 100. The present disclosure is not limited to this configuration. For example, the information processing apparatus 1 may include the information analysis apparatus 2 alone and execute a training model DB 2003 by inputting conversation information. Alternatively, the information processing apparatus 1 may include the information analysis apparatus 2 and the terminal apparatus 3, and the terminal apparatus 3 may receive input of conversation information that indicates a conversation between two persons. The number of terminal apparatuses is not limited to two, and multiple terminal apparatuses may be connected to the communication network 100 to execute processes.

The communication network 100 is a communication network through which an unspecified number of communications are established and is implemented by, for example, the Internet, an intranet, or a local area network (LAN). The communication network 100 may be a wired communication network or a wireless communication network in compliance with, for example, the fourth generation (4G), the fifth generation (5G), Worldwide Interoperability for Microwave Access (WiMAX), or Long Term Evolution (LTE).

The information analysis apparatus 2 performs information analysis and function as a storage device in the information processing apparatus 1. The information analysis apparatus 2 has the functionality to evaluate the behavior of a user in a one-on-one (1-on-1) meeting. The information analysis apparatus 2 determines whether a tone of voice of the user or the content of a comment of the user is appropriate in evaluating the behavior of the user. The information analysis apparatus 2 further determines whether a facial expression and a nodding timing of the user are appropriate in evaluating the behavior of the user. The information analysis apparatus 2 has the functionality to store information on a trained model or a model example and information on a conversation (conversation information). The information analysis apparatus 2 may be a personal computer (PC) or a portable laptop PC, which is widely used.

The terminal apparatus 3 and the terminal apparatus 4 are communication terminals that are used by users who use the information processing apparatus 1 and can acquire information related to the users. The terminal apparatus 3 and the terminal apparatus 4 functions as input devices for inputting information to be used to the information processing apparatus 1. The input device includes peripheral devices and internal devices such as a keyboard, a microphone, and a camera of a computer terminal. The terminal apparatus 3 or the terminal apparatus 4 provides information to the user. The terminal apparatus 3 or the terminal apparatus 4 functions as a visualizing device to output data such as an arithmetic result obtained from an arithmetic device and information stored in a storage device by displaying the arithmetic result and the stored information on a display for the user. The terminal apparatus 3 or the terminal apparatus 4 is implemented by an information processing apparatus (computer system) for communication, is installed with a general-purpose operating system (OS), and is included in the information processing apparatus 1.

Each of the terminal apparatus 3 and the terminal apparatus 4 may be a PC, a portable laptop PC, a mobile phone, a smartphone, a tablet terminal, or a communication terminal that is widely used. Each of the terminal apparatus 3 and the terminal apparatus 4 may be a communication device or a communication terminal that can run software such as browser software or various applications.

### Hardware Configuration

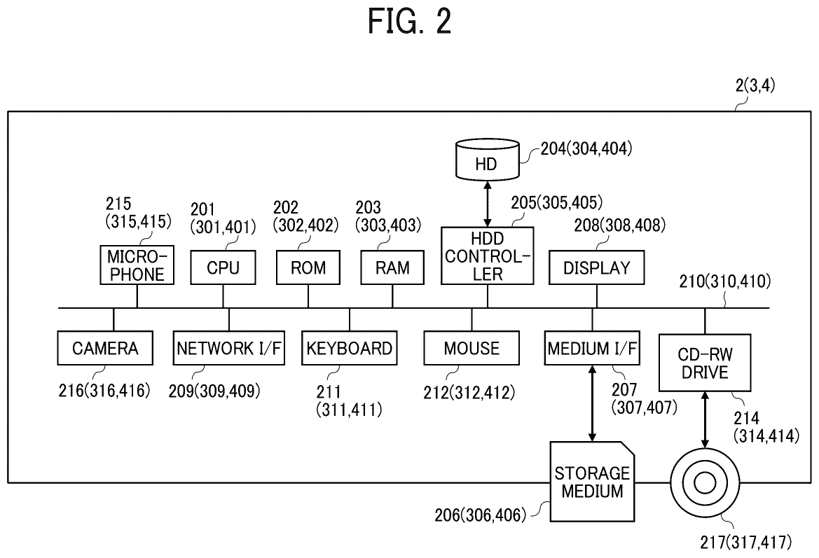

Referring to FIG. 2, a hardware configuration of each of the information analysis apparatus 2, the terminal apparatus 3, and the terminal apparatus 4 included in the information processing apparatus 1 according to the present embodiment is described. In the hardware configuration of the terminal apparatus or the information analysis apparatus illustrated in FIG. 2, a component may be added or deleted as appropriate.

FIG. 2 is a block diagram illustrating a hardware configuration of the information analysis apparatus according to the present embodiment. Since the terminal apparatus 3, the terminal apparatus 4, and the information analysis apparatus 2 have substantially the same configuration, the configuration of the information analysis apparatus 2 is described below, and the description of the configurations of the terminal apparatus 3 and the terminal apparatus 4 are omitted. As illustrated in FIG. 2, the information analysis apparatus 2 is implemented by, for example, a computer, and includes a central processing unit (CPU) 201 (301, 401), a read-only memory (ROM) 202 (302, 402), a random-access memory (RAM) 203 (303, 403), and a display 208 (308, 408). The information analysis apparatus 2 further includes a network interface (I/F) 209 (309, 409), a keyboard 211 (311, 411), a mouse 212 (312, 412), a microphone 215 (315, 415), a camera 216 (316, 416), and a medium I/F 207. The reference numerals in parentheses denote the reference numerals of the terminal apparatus 3 and the terminal apparatus 4.

The CPU 201 (301, 401) performs overall control of the information analysis apparatus 2 (the terminal apparatuses 3 and 4). The ROM 202 (302, 402) stores a program used for driving the CPU 201 (301, 401). The RAM 203 (303, 403) is used as a working area for the CPU 201 (301, 401). The display 208 (308, 408) displays various information such as a cursor, a menu, a window, characters, and an image. In the present embodiment, the display 208 (308, 408) functions as an example of a display device.

The HD 204 (304, 404) stores various data such as programs. The HDD controller 205 (305, 405) controls the reading or writing of various data from or to the CPU 201 (301, 401) under the control of the HD 204 (304, 404). The information analysis apparatus 2 (the terminal apparatus 3, the terminal apparatus 4) may have a hardware configuration that includes a solid state drive (SSD) as an alternative to the HD 204 (304, 404) and the HDD controller 205 (305, 405).

The microphone 215 (315, 415) and the camera 216 (316, 416) are devices for acquiring, for example, comment audio and facial expression of the user in a 1-on-1 meeting held using the terminal apparatuses 3 and 4. The devices are managed and controlled by the CPU 201 (301, 401). The input audio information and image information are stored in the ROM 202 (302, 402) or the HD 204 (304, 404).

The network I/F 209 (309, 409) is an interface for communicating data using the communication network 100. The keyboard 211 (311, 411) or the mouse 212 (312, 412) is a type of input device for operating the information analysis apparatus 2 (terminal apparatus 3, terminal apparatus 4) according to a user operation such as pressing, clicking, or tapping on a predetermined button or icon on the display 208 (308, 408). The medium I/F 207 (307, 407) controls the reading or writing (storing) of data from or to a recording medium (storage medium) 206 (306, 406) such as a flash memory. The above components such as the CPU 201 (301, 401) are electrically connected with each other by a bus line 210 (310, 410). Examples of the bus line 210 (310, 410) include an address bus and a data bus.

For example, the above-described programs may be recorded in file format installable or executable on a computer-readable recording medium for distribution. Examples of the recording medium include a compact disc recordable (CD-R), a digital versatile disc (DVD), a BLU-RAY disc, a secure digital (SD) card, and a non-transitory computer-readable recording medium. Further, such a recording medium may be provided in the form of a program product to users domestically or internationally. For example, the information analysis apparatus 2 (the terminal apparatus 3, the terminal apparatus 4) implements an information analysis method according to the present embodiment by executing a program according to the present embodiment.

Although the three apparatuses of the terminal apparatus 3, the terminal apparatus 4, and the information analysis apparatus 2 perform processes in the present embodiment as the information processing apparatus 1, the information analysis apparatus 2 alone may perform the processes. In such a case, the corresponding units of the analysis apparatus 2 perform processing described later. In this case, the two users use the microphone 215 and the camera 216 included in the information analysis apparatus 2.

### Functional Configuration

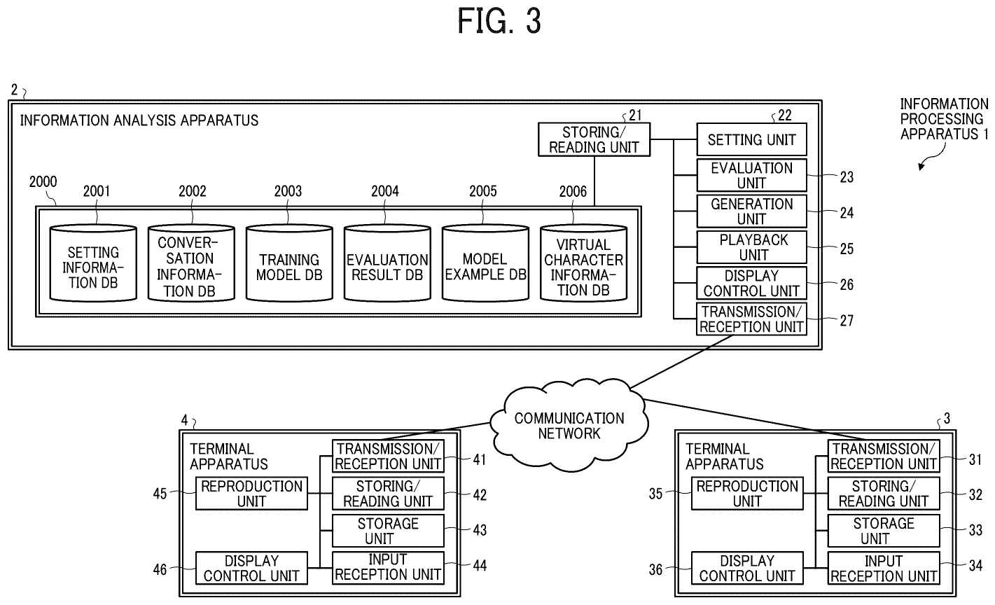

FIG. 3 is a block diagram illustrating a functional configuration of the information processing apparatus 1 according to the present embodiment. The information processing apparatus 1 includes the information analysis apparatus 2, the terminal apparatus 3 and the terminal apparatus 4. Functional units of each apparatus are described below.

### Functional Configuration of Information Analysis Apparatus 2

A functional configuration of the information analysis apparatus 2 is described below. As illustrated in FIG. 3, the information analysis apparatus 2 includes a storing/reading unit 21, a setting unit 22, an evaluation unit 23, a generation unit 24, a playback unit 25, a display control unit 26, and a transmission/reception unit 27. Each of the functional units is a function that is implemented by one or more of the hardware resources illustrated in FIG. 2 operating in response to an instruction from the CPU 201 according to a program for the information analysis apparatus 2 loaded into the RAM 203 from at least one of the ROM 202, the HD 204, and the recording medium 206. The information analysis apparatus 2 includes a storage unit 2000 implemented by at least one of the ROM 202, the HD 204, and the recording medium 206 illustrated in FIG. 2. Further, for example, a communication program (communication application) for communicating with the communication terminal 3 via the communication network 100 and a browser application are installed and stored in the storage unit 2000.

Each functional unit of the information analysis apparatus 2 is described in detail below. The transmission/reception unit 27 of the information analysis apparatus 2 illustrated in FIG. 3 is implemented by, for example, processing of the CPU 201 related to the network I/F 209 and transmits and receives various data (or information) to and from the apparatuses such as the terminal apparatus 3 and the terminal apparatus 4 through the communication network 100.

The display control unit 26 is implemented by, for example, the processing of the CPU 201 related to the display 208 and performs display controls of various screens and information (data).

For example, the display control unit 26 displays a display screen generated by hyper text makeup language (HTML) on the display 208 using a browser. In the present embodiment, the display control unit 26 functions as an example of a display control device.

The evaluation unit 23 is implemented by, for example, processing of the CPU 201 and performs various determination processes in the information analysis apparatus 2. In the present embodiment, the evaluation unit 23 functions as an example of an evaluation device.

The generation unit 24 is implemented by, for example, processing of the CPU 201 and generates various information (data) in the information analysis apparatus 2.

The playback unit 25 is implemented by, for example, processing of the CPU 201 and plays audio (voice) data (information) or video data (information) of conversation information or a model example. In the present embodiment, the playback unit 25 functions as an example of a playback processing device.

The setting unit 22 is implemented by, for example, processing of the CPU 201 and configures user settings managed by the information analysis apparatus 2 or configures settings of information to be displayed.

The storing/reading unit 21 is implemented by, for example, processing of the CPU 201 related to at least one of the ROM 202, the RAM 203, the HD 204, and the recording medium 206 and stores various information (or data) in the storage unit 2000. The CPU also reads various data (or information) from the storage unit 2000. In the present embodiment, the storing/reading unit 21 functions as an example of a storing/reading device.

The storage unit 2000 included in the information analysis apparatus 2 is described below. The storage unit 2000 includes a setting information database (DB) 2001, a conversation information DB 2002, a training model DB 2003, an evaluation result DB 2004, a model example DB 2005, and a virtual character information DB 2006. The setting information DB 2001 stores user setting information input by a user, for example, with the keyboard 311 of the terminal apparatus 3.

The conversation information DB 2002 stores, in a file format, audio information, image information, and video information that are generated by the microphones (315, 415) and the cameras (315, 415) of the terminal apparatuses 3 and 4 when the 1-on-1 meeting is held using the terminal apparatuses 3 and 4.

The evaluation result DB 2004 stores a list of file names stored in the conversation information DB 2002 and a character string generated from the audio information. The evaluation result DB 2004 stores final evaluation items and intermediate evaluation items for evaluating 1-on-1 meetings as a table. The time when the information is generated is listed and stored in the audio information and the video information. Further, time stamps corresponding to character strings and the evaluation items are generated and stored in a corresponding table format. This table allows the display control unit to arrange the character strings and the evaluation items in chronological order (in time series) when the users spoke.

The training model DB 2003 accumulates training models for evaluating the behavior of the user from information such as audio information, image information, video information, and character strings. The training model includes a training dataset and a training algorithm. The training dataset indicates the relationship of behavior with audio information, image information, video information, and character strings.

The model example DB 2005 stores file names of model examples in a table format for each evaluation item. A file of a model example includes audio information representing model audio, image information representing a model image, video information representing a model video, and character strings being a model.

In the above-described system, the function of the storage unit may be implemented by a cloud server.

The cloud server is a server that provides a resource of cloud computing.

### Functional Configurations of Terminal Apparatus 3 and Terminal Apparatus 4

The functional configurations of the terminal apparatus 3 and the terminal apparatus 4 are described below. As illustrated in FIG. 3, the terminal apparatus 3 (the terminal apparatus 4) includes a transmission/reception unit 31 (41), a storing/reading unit 32 (42), a storage unit 33 (43), an input reception unit 34 (44), a playback unit 35 (45), and a display control unit 36 (46). Each of the functional units is a function implemented by one or more of the hardware resources illustrated in FIG. 2 operating in response to an instruction from the CPU 301 (403) according to a program for the terminal apparatuses 3 and 4 loaded from at least one of the ROM 302 (402), the HD 304 (401), and the recording medium 306 (406) to the RAM 303 (404).

Each of the terminal apparatus 3 and the terminal apparatus 4 may be implemented by a single computer such as a general-purpose PC or a portable laptop PC or may be implemented by multiple computers to which divided functions or functional units, such as the storage unit, are allocated as desired. All or a part of the functions of the terminal apparatus 3 or the terminal apparatus 4 may be implemented by a server computer residing on a cloud network or a server computer residing on an on-premises network. The terminal apparatus 3 and the terminal apparatus 4 may be communication devices or communication terminals that can run software such as browser software.

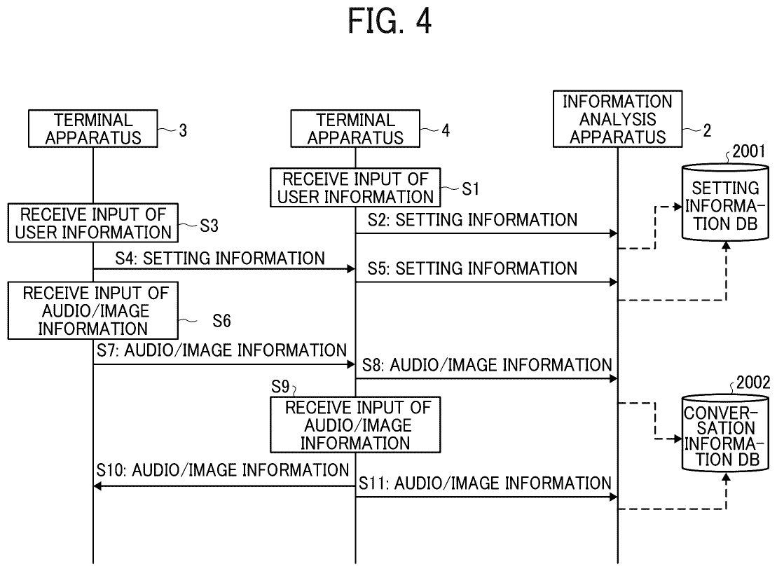

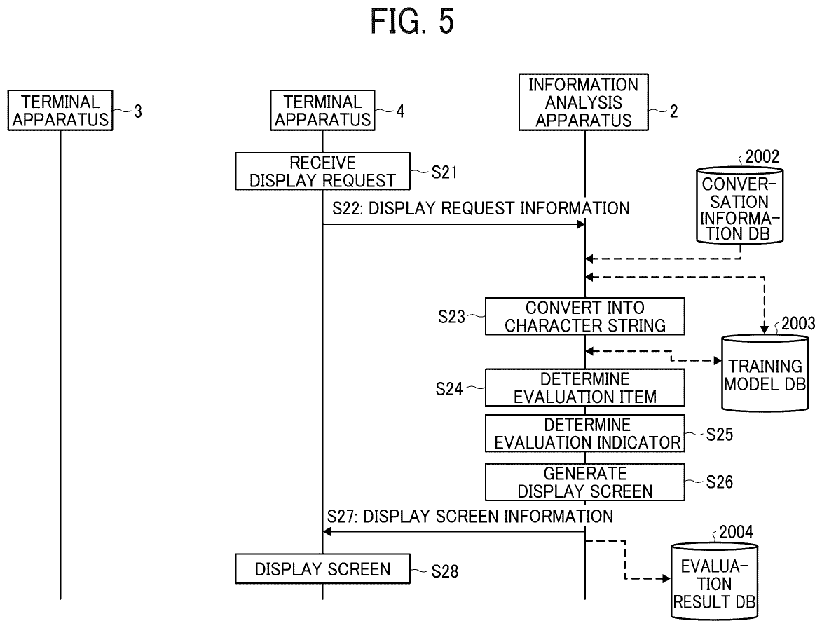

An operation of the system according to the present embodiment is described with reference to sequence diagrams illustrated in FIGS. 4 and 5. In the present embodiment, a case of a 1-on-1 meeting between a supervisor and a subordinate is described. A conversation in the 1-on-1 meeting is recorded. The evaluation device evaluates whether the behavior of the supervisor in the 1-on-1 is appropriate, and the conversation is represented as character strings arranged in chronological order, and the evaluation results for the behavior during the conversation are also displayed alongside the character strings.

FIG. 4 is a diagram illustrating a sequence diagram for recording the 1-on-1 meeting between the supervisor and the subordinate. The subordinate and the supervisor log into the terminal apparatus 3 and the terminal apparatus 4, respectively. In the present embodiment, the supervisor is the user (first user) of the terminal apparatus 4, and the subordinate is the user (second user, additional user) of the terminal apparatus 3. Each terminal apparatus has an authentication system to verify each user's identity using a password. The input reception unit 44 of the terminal apparatus 4 revives input of user information (input information) input by the first user (supervisor) using the keyboard 411 (Step S1). Based on the input information, information on the first user (supervisor) and settings for the 1-on-1 meeting are configured. Items of the settings include user information of the second user (subordinate) and a date and time for the 1-on-1 meeting. Further, evaluation items for evaluating the 1-on-1 meeting can be selected. Further, a file name of audio or a video may be automatically set. The items of the settings are transmitted to the information analysis apparatus 2 (Step S2) and stored in the setting information DB 2001.

The second user (subordinate) logs into the terminal apparatus 3 to which the second user (subordinate) is registered as a user. The authentication system verifies that the second user (subordinate) is the intended participant of the 1-on-1 meeting set in advance. The input reception unit 34 revives input of user information (input information) input by the second user (subordinate) for the 1-on-1 meeting (Step S3). With the input information, a record indicating that the second user (subordinate) has approved the 1-on-1 meeting can be stored. The input information is transmitted to the terminal apparatus 4 and the information analysis apparatus 2 (Steps S4 and S5). The setting items for the 1-on-1 meeting can be shared by the advance approval process described above. It is desired that the second user (subordinate) is checks the settings for the 1-on-1 meeting approximately one to two weeks before, so that the second user (subordinate) can consider a topic in the 1-on-1 meeting in advance.

The 1-on-1 meeting is implemented by communication between the terminal apparatuses 3 and 4 through the communication network 100. The information analysis apparatus 2 stores the records of the communication through the communication network 100 as the conversation information DB 2002. The 1-on-1 meeting is automatically started in response to a call made by the first user (supervisor) to the second user (subordinate) at the pre-set time.

When the 1-on-1 meeting between the subordinate and the supervisor starts, each of the terminal apparatuses 3 and 4 inputs the corresponding audio (voice), image, and video. The terminal apparatus 3 (terminal apparatus 4) is provided with the microphone 315 (415) and the camera 316 (416), and receives information by the input reception unit 34 (44). The microphone 315 (415) can input the comments of the user as audio information (voice information). The camera 316 (416) adjusts the angle of view, the number of pixels, and the amount of exposure so that a facial expression of the user, such as a mouth angle and the movement of eye vicinity, and head movement, such as nodding and head shaking, can be clearly recorded. When the adjustment is not sufficiently performed, the information analysis apparatus 2 provides an advisory alert to guide the user to set appropriate configurations.

The audio information and the video information of the second user (subordinate) input by the input reception unit 34 (Step S6) are stored in the storage unit 33 and transmitted to the terminal apparatus 4 by the transmission/reception unit 31 (Step S7). At substantially the same time, the audio information and the video information of the second user (subordinate) are transmitted to the information analysis apparatus 2 (Step S8). The information analysis apparatus 2 records the audio and the video in the conversation information DB 2002 by the storing/reading unit 21.

The audio information and the video information of the first user (supervisor) input from the input reception unit 44 (Step S9) are stored in the storage unit 43 and transmitted to the terminal apparatus 3 by the transmission/reception unit 41 (Step S10). At substantially the same time, the audio information and the video information of the supervisor are transmitted to the information analysis apparatus 2 (Step S11). The information analysis apparatus 2 records the audio information and the video information in the conversation information DB 2002 by the storing/reading unit 21.

In the case of general conversation information, two or three turns of interactions define one segment as a conversation to be stored as a single data file. Each data file (conversation information) includes tens of seconds of audio information and video information. Each of the terminal apparatus 3 and the terminal apparatus 4 has an accurate timer. The timers of the terminal apparatus 3 and the terminal apparatus 4 are synchronized with each other. The timers accurately record the time when the audio information and the video information are generated by comments of the first user (supervisor) and the second user (subordinate). The exact start and end times of the audio information and the video information are stored with the file names of the audio file and video file. Regarding the accuracy of the time stamps, accurate information can be obtained by setting the time information in units of 0.1 seconds. The time stamps in the terminal apparatus 3, the terminal apparatus 4, and the information analysis apparatus 2 are accurately synchronized. The time information may be stored in the same file having the header of each file, or may be included in the file name. The audio information and the video information also have time stamps having the same times and record the start time and the end time. A time period from the start time to the end time of the audio information and the video information is referred to as a first period and is stored in a table in the evaluation result DB 2004.

In the 1-on-1 meeting, the audio information and the video information as described above are repeatedly recorded. Thus, a file in which each time period is recorded is generated. When the 1-on-1 meeting ends, the communication between the terminal apparatus 4 of the first user (supervisor) and the terminal apparatus 3 of the second user (subordinate) also ends. The end of the 1-on-1 meeting, or the end of the communication, is detected, and a series of conversations in the 1-on-1 meeting is stored as a set of pieces of conversation information in the conversation information DB 2002. The entire meeting may be stored in one video/audio file without being divided by units of conversations (two or three turns of interactions) and may be divided later. In this case, the data or the information may be transmitted at the end of the meeting, but not during the meeting. A method for transmitting image information or video information including audio recorded by a widely-used meeting tool to the information analysis apparatus 2 of the information processing apparatus 1 and analyzing the information without using the terminal apparatus 3 may be used.

A method for generating an evaluation of the behavior of the first user (supervisor) in the 1-on-1 meeting is described below. FIG. 5 is a sequence diagram illustrating an operation of generating evaluation information. The input reception unit 44 receives an input of a request for screen display (display request information) via the keyboard 411 or the mouse 412 of the terminal apparatus 4 used by the first user (supervisor) (Step S21). The transmission/reception unit 41 transmits the display request information to the information analysis apparatus 2 (Step S22). The request for screen display may be made at any time as long as the information is stored in the conversation information DB 2002. In general, after a 1-on-1 meeting ends, the first user (supervisor) often makes a request for screen display to reflecting on the meeting to enhance his or her skills in 1-on-1 meetings by taking time.

Further, since data is stored in the conversation information DB 2002 in the middle of the conversation (during the meeting), a request for screen display can be made substantially in real time. In this case, the behavior of the user can be evaluated in almost real time, and the feedback can be provided at that time. For example, if a determination indicating there is little smile is provided, the user can reflect on the determination in real time by intentionally lifting his or her corner of the mouth. This allows the user to enhance his or her skills in 1-on-1 meetings in real time.

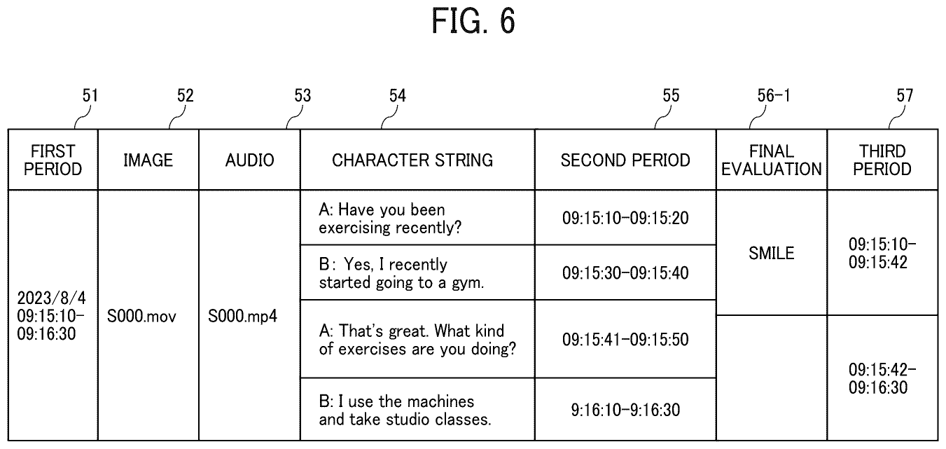

The generation unit 24 generates a character string from the audio information previously recorded. The training model DB 2003 in which a training model trained on audio (voice) data is provided for generating character strings from the audio information. The generation unit 24 generates the most appropriate character string by calculating the rate of coincidence between the recorded audio and the character string of the training model by using the training model DB 2003 (Step S23). The generated character string is stored with a time stamp so that the audio information and the character string are associated with each other. The time information to be added to the character string is stored as a time corresponding to the number of words for about one line of the character string. The delimiter between character strings that correspond to comments is appropriately generated by detecting either the meaning of the comment or a period of silence. For example, the character strings are segmented in chronological order, where each comment represents a meaningful unit of speech produced by a speaker. The time period corresponding to the time information is stored as a second period. FIG. 6 is a diagram illustrating an example of a table in which a character string and a second period are recorded.

In the table of FIG. 6, a date and time when a file is generated is recorded as a first period 51. File names (image 52 and audio 53) corresponding to the video information and the audio information are stored in association with each other. As a character string 54 a character string generated from the audio file is recorded. As a second period 55 a time period corresponding to a character string is stored in association with the character string. As a final evaluation item 56-1 a final evaluation item for behavior of the first user (supervisor) is stored. As a third period 57 a time period of a final evaluation item is stored.

In the present embodiment, the behavior of the first user (supervisor) is evaluated based on the audio information and the video information (Step S24). The behavior of the first user (supervisor) in a 1-on-1 meeting is a factor for enhancing the quality of the 1-on-1 meeting. A method for determining the behavior is described below.

In the present embodiment, the evaluation unit 23 can evaluate the behavior by comparison with the training model DB 2003. For example, a tone of voice of the user and the timing of utterance are determined based on the audio information. Further, the content of the comment can be determined from the character string, and whether the comment is appropriate can be determined. Further, whether the facial expression at that time is appropriate can be determined based on information on the face.

Further, nodding can be detected based on head movement, and whether the nodding timing is appropriate can be determined. A specific determination method is described below.

The conversation information DB 2002 stores, for example, facial expressions and actions as image/video information. The facial expression is obtained based on a feature extracted from the face region of the user included in the image information. Which facial expression parameter corresponds to the obtained facial expression is determined. The facial expression parameters are counted for each predetermined period, and the counting result is stored. The facial expression parameters include anger, contempt, disgust, anxiety, joy, sadness, surprise, and neutral. As the action, a result obtained by calculating the movement amount of each body part of the user included in the video information is stored. The action parameters (actions) include head movement, body movement, lip movement, and eye movement. For example, as the head movement, the position of the head of the user is detected from the video information, and the average value of the movement amount for each predetermined period, which is derived by calculating the movement amount of the position of the head, is stored. The posture and gesture of the user are analyzed based on the result of the action.

The microphone 315 (415) that is an example of audio information acquisition device and acquires audio information such as a tone, the number of utterances/duration of utterances, the number of silences/duration of silence, and content of utterance. As the tone, a feature obtained by performing language analysis on the audio information and calculating a pitch pattern of a sound used for distinguishing the meaning in the language is stored. As the number of utterances/duration of utterances, the frequency or duration of utterances made by the user in the 1-on-1 meeting is recorded. As the number of silences/duration of silence, the frequency or duration of silence made by the user or the other user (interviewee) in the 1-on-1 meeting is recorded. As the content of utterance, text corresponding to the content of an utterance of the user in the 1-on-1 meeting is recorded. An interactive skill analysis device includes an image analysis unit and an audio analysis unit, and the image analysis unit counts the number of nods and the number of smiles of the user. The audio analysis unit counts the number of positive receptions, the number of considerations, the number of back-channel responses, and the ratio of utterance of the user.

The final evaluation item 56-1 illustrated in FIG. 6 indicates an evaluation result such as a facial expression. An example of an evaluation item is “smile”, which can be determined from the angle of the mouth corner recorded in the image as described above.

As illustrated in FIG. 6, a time period during which “smile” is determined (detected) is stored as a third period. The third period is a time period in which an evaluation is determined, and for example, a time when the mouth angle is increased and exceeds a certain threshold value is stored as a start time, and a time when the mouth angle is decreased and falls below the threshold value is stored as an end time. The third period 57 and the second period 55 are synchronized in time, but the start and end times stored therein do not need to coincide with each other. The third period 57 may extend over the second period 55 or may coincide with the second period 55.

As illustrated in FIG. 6, the final evaluation item 56-1 may include a blank time period for which no evaluation item is present. In this way, the final evaluation item 56-1 is determined throughout the entire duration of the 1-on-1 meeting.

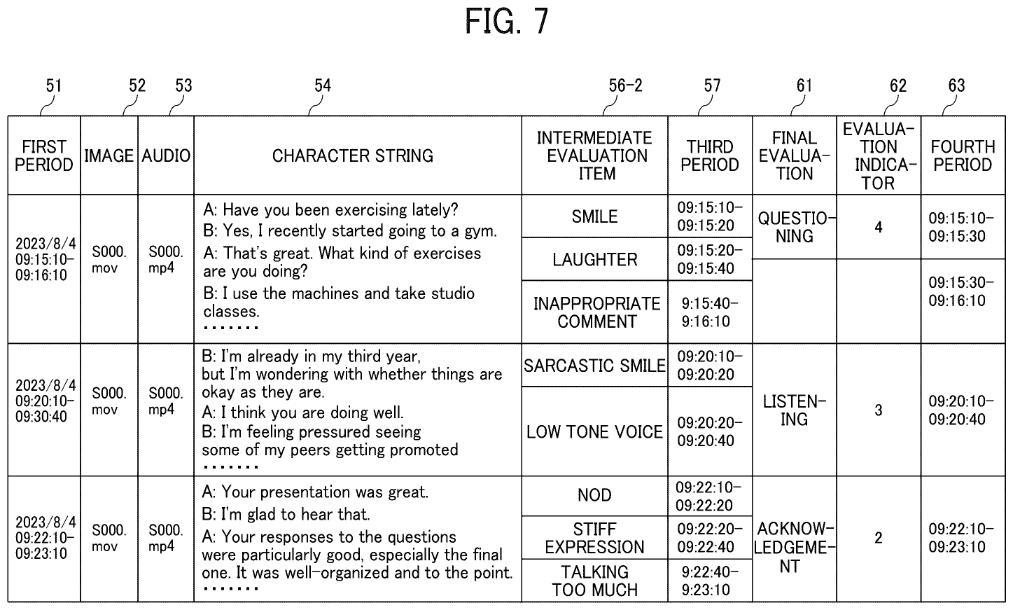

FIG. 7 is a diagram illustrating another example of a table in which evaluation for a 1-on-1 meeting is recorded. In the example of FIG. 7, not only a final evaluation item 61 but also an evaluation indicator 62 is recorded. The final evaluation item 61 and an intermediate evaluation item 56-2 are clearly described as final and intermediate when two stage evaluation is performed. Since the final and intermediate are not strictly distinguished, they may be interchanged. For the intermediate evaluation item 56-2, not only “smile” but other facial expression including “nod” and a “stiff expression” that can be determined from an image or a vide are used. When the content of a comment is not preferable as a comment, the comment may be evaluated as an “inappropriate comment”. Further, for example, as the tone of voice or the rhythm of conversation, the supervisor “talking too much” is one of the evaluation items. In the table of FIG. 7 eight intermediate evaluation items are included, the present embodiment is not limited to these. The number of evaluation items can be increased as appropriate by including evaluation items considered to be used by the user in the training model DB 2003.

The intermediate evaluation item 56-2 is information that is used as a reference material for evaluation of the final evaluation item 61.

In the present embodiment, the most useful three elements such as questioning, listening (active listening), and acknowledgement for measuring the communication skills, particularly in 1-on-1 meetings, are extracted for the final evaluation item 61. Whether the first user (supervisor) behaves appropriately is evaluated as the final evaluation item 61. The intermediate evaluation item may be displayed so that the user can review, in addition to being used as a reference material for determining a final evaluation item. If the amount of information becomes excessive by displaying the intermediate evaluation items, the intermediate evaluation items information may not be displayed and hidden from the display.

There are appropriate behavior methods for each of questioning, listening, and acknowledgement. In evaluating whether one can demonstrate appropriate behavioral approaches or possesses those abilities or skills, the above described elements may be referred to as a questioning skill, a listening skill, and an acknowledgement skill. The generation unit generates an evaluation indicator for each appropriate behavior by a training model. The basic concept for determining the indicator is described below.

The listening skill is a basic skill for appropriate communication. The appropriate communication is also called a dialogue skills and is determined from the number of extracted nods, the number of smiles, the number of back-channel responses, and the ratio of utterance.

The listening skill is evaluated from the viewpoint of empathy in addition to the above determination items. The emotion of the users is analyzed based on information on the facial expressions and the audio information, and when the degree of matching between the emotion of the second user (subordinate) and the emotion of the first user (supervisor) is high, it is determined that empathy is made. For example, in the case where the second user (subordinate) expresses joy and the first user (supervisor) also expresses joy following the second user (subordinate), this can be said that the first user (supervisor) empathizes with the second user (subordinate). The empathy is one of the factors for listening.

The acknowledgement skill is determined from the number of positive receptions and the number of considerations. These can be quantified by counting the number of positive words, basically taking into account the content represented by a character string. For example, words having meanings such as “you did well”, “it was good”, and “it was great” are listed, and the number of times a word having a meaning matching one of the listed words is spoken is counted to determine for the acknowledgement skill. In addition, the acknowledgement skill can be determined based on elements included in the image information, such as elements of positive reception facial expression, back-channel response, and nod. By counting these behaviors, an accurate determination for the acknowledgement skill can be made.

For the questioning skill, the number of open questions is calculated. The open question can increase chances for the second user (subordinate) to speak freely, and this allows the second user (subordinate) to select a topic what he or she wants to talk about. Whether such an open question is appropriately performed is determined. However, there is a type of question that corners the counterpart, such as “Why you can't do that?”. In this case, points are deducted in the questioning skill and the acknowledgement skill. That is, the number of open questions is counted, and the quality of each open question can be also determined. The words of the open question are listed and each word is given a coefficient. The coefficient is a positive coefficient in an effective use case, and a negative coefficient is added in a bad use case. This quantifies the questioning skill.

The evaluation indicator 62 for each of the determined listening skill, acknowledgement skill, and questioning skill is recorded on a five-point (five-level) scale (Step S25) as illustrated in the table of FIG. 7. The evaluation indicators are also referred to as scores.

The configurations described above may be combined with other components, and the embodiments of the present disclosure are not limited to the above-described configurations. Any one of the above-described configurations may be modified in various other ways without departing from the gist of the present disclosure and can be appropriately determined according to the application form.

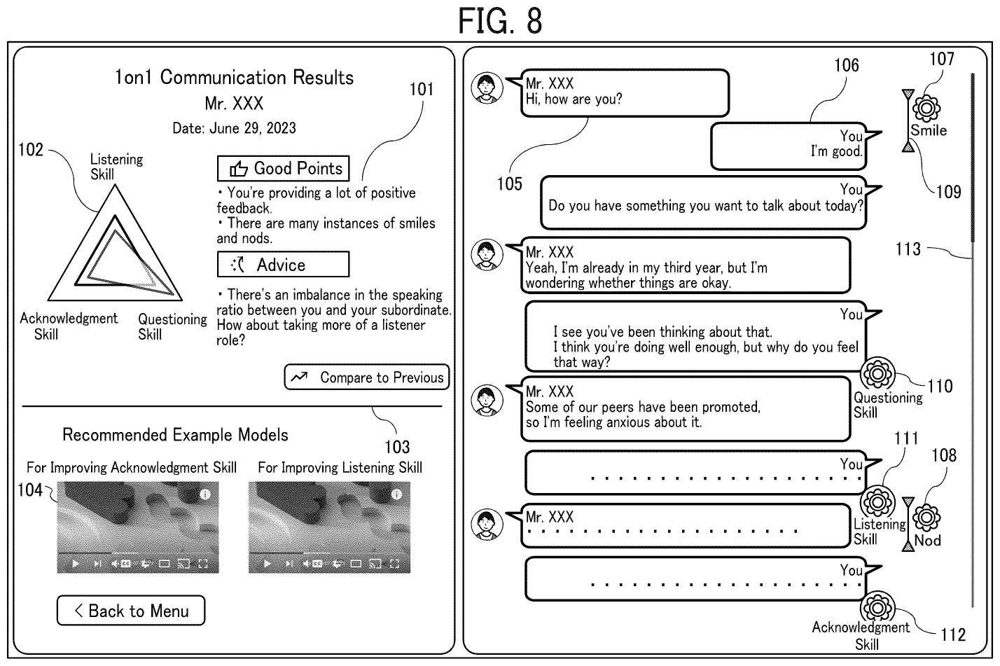

Subsequently, the generation unit 24 generates a display screen (display screen information) (Step S26). FIG. 8 is a diagram illustrating an example of a display screen according to the present embodiment. The example of the display screen is described in detail with reference to FIG. 8.

On the left of the display screen, an evaluation section including an overall evaluation regarding a 1-on-1 meeting is displayed. Further, on the right of the display screen, character strings are displayed in chronological order, in addition to individual evaluation items for some of the character strings and indicators of the individual evaluation items.

As an overall evaluation of the 1-on-1 meeting, an overall evaluation (advice) 101 describes good points and bad points with two to three lines for each. Such short sentences leave an impression on the user. The generation unit 24 generates sentences in the overall evaluation (advice) 101 based on, for example, the final evaluation items of the listening skill, the acknowledgement skill, and the questioning skill, or the mean values of the intermediate evaluation items such as smile and nod, provided for the entire time of the 1-on-1 meeting.

The listening skill, acknowledgement skill, and the questioning skill are illustrated with a radar chart 102. The evaluation for each item is made in a five-point scale and visualized by the radar chart 102. This allows the user to view the balance of the behavior in the 1-on-1 meeting.

Since the radar chart 102 is digitized, a screen change button 103 may be generated to be added so that the user can compare the radar chart with a record of another 1-on-1 meeting in the past.

The display screen includes a frame 104 to play a video (audio and image) that is a model example for communication between a subordinate and a supervisor.

The character strings are arranged in chronological order on the right of the display screen. As the character strings, comments 105 of the subordinate and comments 106 of the supervisor are arranged and displayed. In the present embodiment, the comments may be displayed with dialogue bubbles as illustrated in FIG. 8 to make it easy to visualize the comments. The comments are arranged in chronological order based on the time stamps illustrated in FIG. 6 or 7. The character strings corresponding to the subordinate are generated from the audio input with the terminal apparatus 3. The character strings corresponding to the supervisor are generated from the audio input with the terminal apparatus 4. A face image or a name is displayed for the character strings of the second user (subordinate) so that the first user (supervisor) can recognize who is the counterpart.

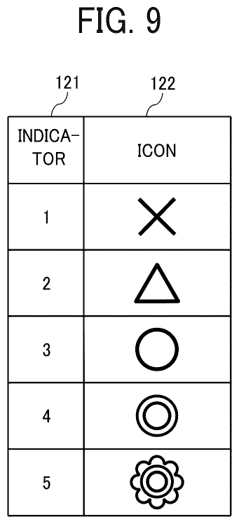

The comment 106 of the supervisor are displayed using, for example, a shape or a color different from that of the comment 105 of the subordinate so that the comments of supervisor and the comments of the subordinate can be distinguished. An icon 107 for an intermediate evaluation item is displayed next to a dialogue bubble of the supervisor. The text “smile” as an intermediate evaluation item and the indicator for “smile” are displayed. The indicators are presented (displayed) in a five-point scale. As illustrated in FIG. 9, icons 122 corresponding to indicators 121 in a five-point scale are used because icons are more intuitive than text or numbers. As icons corresponding to the five-point scale, a flower shape represents the highest score, a double circle shape represents the next highest, a circle shape represents the middle score, a triangle shape represents the second lowest score, and a cross shape represents the lowest score.

The icon 107 for an intermediate evaluation item that indicates an evaluation of the behavior of the supervisor while he or she is making one of the comments 106 is displayed next to the one of the comments 106 of the supervisor. The icon 107 is displayed with the text of “smile” as a display component and has a flower shape representing the highest score as the evaluation indicator. Further, the length of the time axis indicating how long the evaluation item of “smile” has continued is displayed with a bar 109. The length of the time axis is obtained using the third period 57 in the table of FIG. 6.

This allows the user to recognize the evaluation item and the level of the evaluation indicator at a glance. Further, a display component including an icon and text is present next to a corresponding character string of a comment, and this allows the user to intuitively understand that an evaluation indicator and an evaluation item correspond to the same time period of the character string of the comment and easily recall what emotion the supervisor himself or herself felt at that time. This ease of recall is one of factors for improving the 1-on-1 skills in the present system. The user can contribute to improvement of his or her skill by objectively repeating his or her behavior and understanding the behavior together with convincing facts.

The icon 107 for an evaluation item of “smile” is an icon for an intermediate evaluation item as described above. The intermediate evaluation item is arranged at a small distance from the comment 106. On the other hand, an icon 110 for “questioning skill” that is a final evaluation item is arranged at a position where the dialogue bubble comes into contact. The positions of the final evaluation item and the intermediate evaluation item are intentionally made different. Arranging the final evaluation item at a position close to the dialogue bubble including a comment allows the user to more unconsciously understand that the content of the comment is determined. When a temporal element is added as in the case of “smile”, the evaluation item (icon) is arranged with the bar 109 indicating the time period on the outer peripheral portion. On the other hand, when the comment itself is evaluated, the evaluation item (icon) is displayed adjacent to the dialogue bubble. As described above, the placement of the evaluation item (icon), depending on its distance from the dialogue bubble, suggests its effect on the final evaluation item. That is, this allows the user to understand what is the most important and what is the least influential with respect to the final evaluation item. To the user, conveying the final evaluation items is more important than conveying the intermediate evaluation items. In the description of the present embodiment, the final evaluation items are three items of “questioning skill”, “listening skill”, and “acknowledgement skill”, and the others are intermediate evaluation items. However, the way of distinguishing between the final evaluation item and the intermediate evaluation item is not limited thereto.

The three types of final evaluation items are used as illustrated in FIG. 8 with the icon 110 for “questioning skill”, an icon 111 for “listening skill”, and an icon 112 for “acknowledgement skill”. Each of the final evaluation items has an indicator in a five-point (five-level) scale and displayed as an icon that is intuitively understandable as illustrated in FIG. 9. Some dialogue bubbles may not correspond to any items, and in such a case, no icon may be displayed for them.

The information processing apparatus 1 according to the present embodiment is characterized by displaying the evaluation item indicating an evaluation for a comment of a user on the display 408 in association with the character string of the comment. The display control unit 46 is characterized by displaying, on the display 408, the character strings of the comments and the corresponding evaluation items in chronological order. Further, the character strings of comments of another user before and after a comment of the user are also displayed. The display control unit 46 is characterized by displaying an evaluation indicator for an evaluation item in association with the evaluation item. This allows the user to easily understand the comment and the evaluation item in association with each other, resulting in enhancing the satisfaction with evaluation or acceptance of evaluation. This increases the effectiveness of assisting in enhancing communication skills. The character strings of the comments arranged in chronological order allows the user to easily recall the behavior of the user. As a result, the satisfaction with the evaluation items is increased. Visualizing an interaction with the other user allows the user to recall the behavior of the user in the interaction, thereby enhancing the satisfaction with the evaluation items.

In the information processing apparatus 1 according to the present embodiment, the evaluation item includes at least one of an acknowledgement skill, a listening skill, and a questioning skill that are items related to an interactive communication skill. The evaluation item includes at least one of a facial expression, a tone of voice, and a gesture, which are items related to an impression from the user. Thus, the communication in a 1-on-1 meeting can be evaluated, and this allows the user, the first user (supervisor), to improve his or her behavior to give better impression to the other user such as the second user (subordinate). Accordingly, the effectiveness of assisting in enhancing communication skills useful for 1-on-1 meetings is increased.

Displaying the evaluation items in a way as described above can avoid a situation where a “supervisor talks too much”. As a method to enhance the supervisor's communication skills, behavior such as nodding or smiling at appropriate times during each subordinate's comment can be employed. This promotes awareness and improves behavior such as active listening, acknowledging, and asking relevant questions based on the content of the comment.

Conducting 1-on-1 meetings effectively can prevent the atmosphere of feeling unrewarded despite hard work from developing internally, resulting in enhancing engagement in the workplace. Further, conducting 1-on-1 meetings effectively leads each employee to autonomously set goals and carry out tasks, and individuals can actively reassess the meaning of their work and their responsibilities. This can lead the individuals to a stance of designing their careers autonomously.

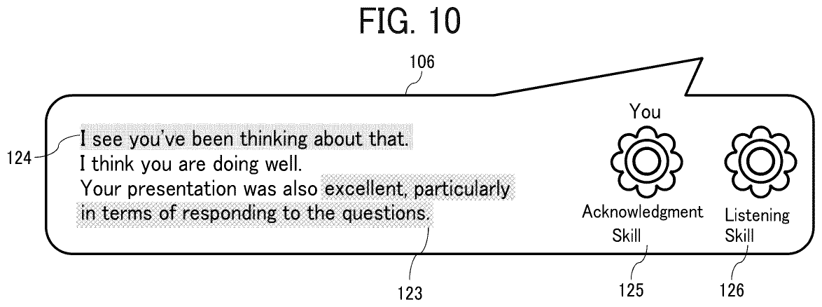

As a first variation, the positional relationship between a dialogue bubble of a comment and an evaluation item may be as illustrated in FIG. 10. FIG. 10 is a diagram illustrating an example of the positional relationship between a dialogue bubble including a comment and an evaluation item. In the example of FIG. 10, an icon 125 for “acknowledgement skill” that is one of the final evaluation items is arranged in a dialogue bubble of the comment 106 of the supervisor. Further, for example, a character string that serves as an evaluation factor for the evaluation item is highlighted as a highlighted character string 123 in FIG. 10. By so doing, the relationship between the evaluation item (icon 125 for “acknowledgement skill”) and the highlighted character string 123 is clearly visualized. This allows the user to recognize the relationship between the user's comment and the evaluation item. Clearly visualizing this relationship has an effect of improving the skill of the first user (supervisor). The goal of skill is to make the player unconsciously act, unlike knowledge. Therefore, it is important to repeatedly list the comments and the evaluation items and to learn them as potential memories. Further, two icons corresponding to two final evaluation items may be arranged. In the example of FIG. 10, as the final evaluation items, an icon 126 for “listening skill” and the icon 125 for “acknowledgement skill” are arranged in parallel.

Further, a character string serving as an evaluation factor for the evaluation item (listening skill) is a highlighted character string 124 that is a character string highlighted in a color different from the highlighted character string 123. Since the colors used for highlighting are different from each other, the highlighted character strings 123 and 124 can be distinguished from each other. The icon 125 for “acknowledgement skill” and the icon 126 for “listening skill” that are icons for the final evaluation items may not be displayed. Alternatively, the corresponding character strings may be highlighted using different fixed colors. For example, the character strings serving as the evaluation factor for “listening skill” may be highlighted in blue, and the character strings serving as the evaluation factor for “acknowledgement skill” may be highlighted in red.

According to the display method described above, it is easy to recall which part of the communication is being referred to from the chronologically ordered comments of the participants. The user can confirm his or her specific behavior in the scene. This allows the user to easily reflecting on his or her behavior and to improve the quality of communication.

### Assisting Reflection

The evaluated skills of the first user (supervisor) in the 1-on-1 meeting can be used to enhance his or her skill. First, objective reflection of the evaluation result is useful for the user. In the present embodiment, a system for facilitating the reflection is provided.

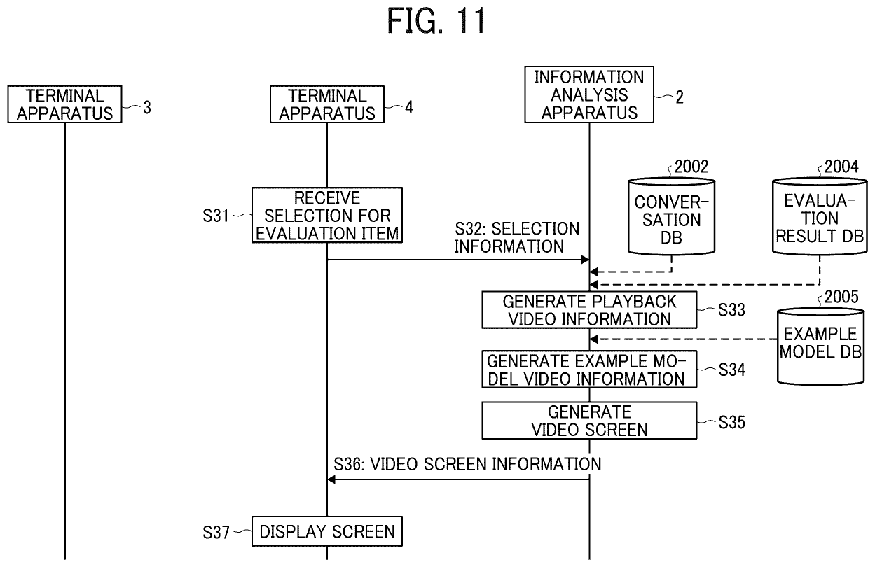

FIG. 11 is a sequence diagram illustrating an example of a process for assisting reflection. The sequence diagram of FIG. 11 may be a continuation of the sequence of FIG. 5. The user (first user) views the display screen illustrated in FIG. 8 to take an overview. Typically, the user's interest is in each of the evaluation items. Therefore, the user (first user) reads the evaluation items one by one. Then, the user (first user) often seems to recall and analyze how his or her evaluations were derived from character strings. At this time, the cursor is moved according to a user operation to the display button of the evaluation item (for example, the icon 110 for “questioning skill”) to which user's attention is paid, and the button is clicked by the user (first user). Thus, the evaluation item is selected, and the input reception unit 44 receives selection information accordingly (Step S31). The selection information may include information for displaying a model example described later. When the selection information includes the information for displaying a model example, information on the model example is displayed. The transmission/reception unit 41 transmits the selection information to the information analysis apparatus 2 (Step S32).

Upon receiving the selection information, the information analysis apparatus 2 refers to the correspondence table in the evaluation result DB 2004. For example, in the table of FIG. 7, when “QUESTIONING” of the final evaluation item 61 is selected, the data files of the image 52 and the audio 53 corresponding to “QUESTIONING” are selected. The playback unit 25 plays a display image and audio based on the data to generate playback video information (Step S33).

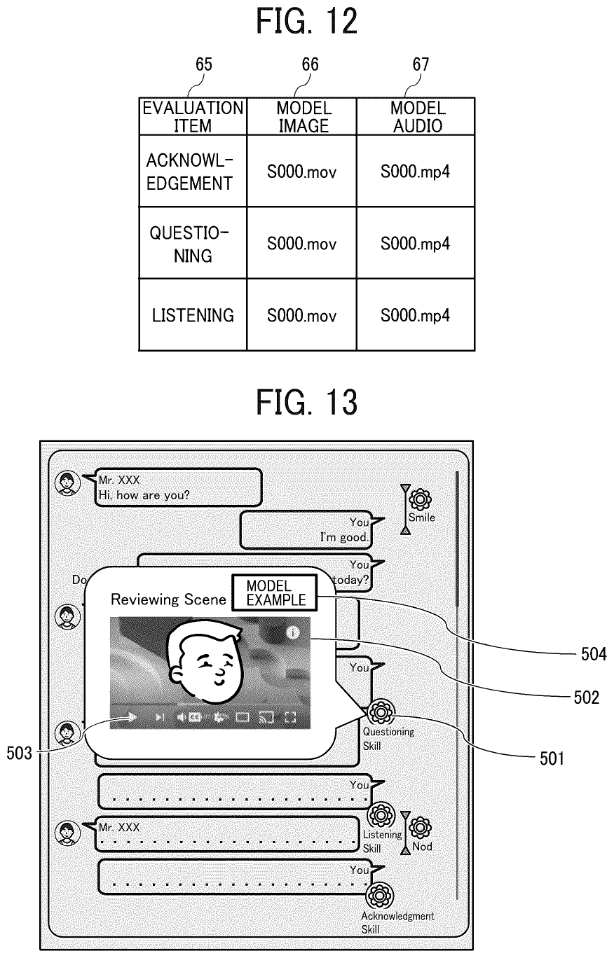

Further, if there is an instruction from the user (first user), a model example may be displayed. The information analysis apparatus 2 includes the model example DB 2005 that stores a model image and model audio as files for the evaluation item 65 as illustrated in FIG. 12. The model image and the model audio may be a single video file. Although a single file is stored for each evaluation item in the table of FIG. 12, multiple files may be prepared for each evaluation item. The files may be selected in order according to an instruction, or a function of automatically selecting an appropriate file by associating the file may be provided. The playback unit 25 plays the selected file, and model example video information is generated (Step S34).

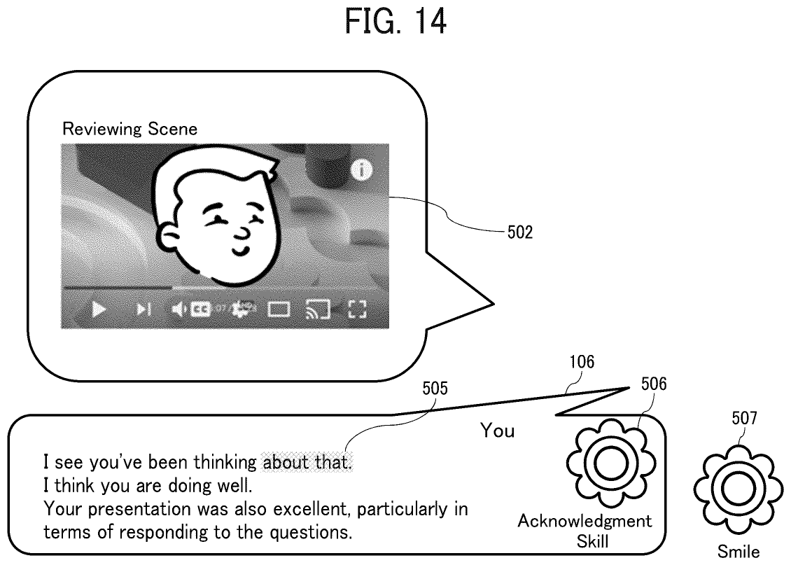

The generation unit 24 generates a display screen including the playback video information and the model example video information to be displayed on the terminal apparatus 4 (Step S35). The transmission/reception unit 27 transmits the video and the screen information to the terminal apparatus 4 (Step S36). The display control unit 46 displays, on the display 408, the screen (Step S37). FIG. 13 is a diagram illustrating an example of a display screen. The screen illustrated in FIG. 13 is a display screen that is generated when an icon 501 for an evaluation item is selected and clicked using the mouse 412. A pop-up screen including a video frame 502 in which a video is to be played is displayed near the center. The video with embedded image and audio files is played in response to a user operation of pressing a button 503. Further, a model example can be played by clicking a button 504 labeled “MODEL EXAMPLE” with the mouse 412.

FIG. 14 is a diagram illustrating an example of a display screen according to a second variation. As illustrated in FIG. 14, a highlighted portion 505 on a character string corresponding to audio being played may also be dynamically moved. This allows the first user (supervisor) to simultaneously check his or her comment audio and the corresponding character string. Further, an icon 507 may have a function for blinking clearly when the video is played, so that the user can easily recognize the corresponding determination. For example, when a video being played corresponding to a determination for “smile”, the icon for “smile” blinks. The blinking time can be managed by comparing the third period 57 in FIG. 6 to a time period during which the video is played.

This allows the user to understand the criteria used for smile determination, for example, when and what kind of facial expression is determined as a smile, while checking his or her own facial expression in the image. As a result, the user can understand his or her facial expression and the objective determination criteria with satisfaction.

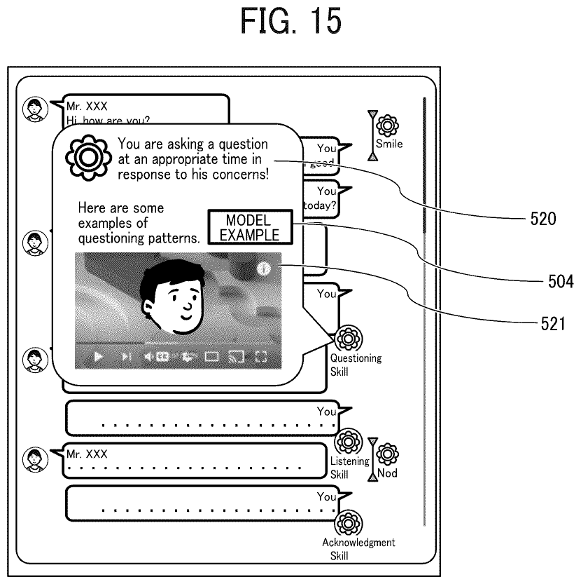

As illustrated in FIG. 15, advice 520 for the selected evaluation item may be displayed. The advice is generated by the generation unit 24 of the information analysis apparatus 2. Thus, the user is provided with advice on each part of the communication for the overall evaluation (advice) 101 of the entire 1-on-1 meeting in FIG. 8. This allows the user to deepens understanding as points for reflection and leads an enhancement in the user's skill. Further, a video of a model example for the same evaluation item may be played. The button 504 labeled “MODEL EXAMPLE” may be displayed to prompt the user to play the video, and the video is played when the button 504 is clicked. Viewing the model example allows the user to recognize the difference between the user's behavior and the model example, this can lead to an enhancement in the user's skill.

The model example may use the training model DB 2003 used for the evaluation items. For example, a character string of a model example stored in the training model DB 2003 may be presented. Further, a character string to be presented may be obtained by changing a variation from a character string of a model example stored in the training model DB 2003. Many variations may be generated by a generative artificial intelligence (AI). Further, not only the character strings but also image information, audio information, and video information may be generated by a generative AI. The generative AI can create various model examples, and an appropriate one of the various model examples can be selected to be presented to the user. As a result, the efficiency of skill enhancement increases.

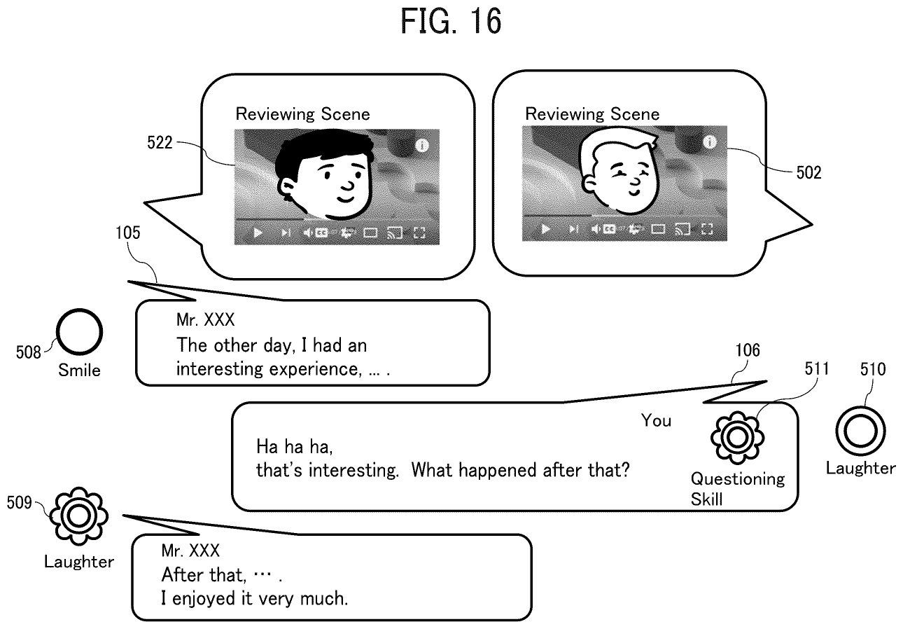

FIG. 16 is a diagram illustrating an example of a display screen according to a third variation. In the third variation, a video frame 522 corresponding to the second user (subordinate) is arranged in parallel with a video frame 502 corresponding to the first user (supervisor). Playing the videos in synchronization gives a realistic atmosphere and allows the user to recall the 1-on-1 meeting. Further, the evaluation may be made based on the audio information or the image information of the second user (subordinate). The evaluation method is the same as the method used for evaluating the audio information or the image information of the first user (supervisor) described above. For example, an icon 508 for “smile” or an icon 509 for “laughter” are arranged. With this arrangement of the display screen, the reaction of the second user (subordinate) to the behavior of the first user (supervisor) can be checked. That is, the emotion of the counterpart with respect to the behavior indicated by the comment 106 of the first user (supervisor) or the icon 510 for the intermediate evaluation item can be read. This reaction may also be used for an indicator of the evaluation item to determine the icon 511 for the final evaluation item. In fact, the emotion of the second user (subordinate) is the most influential factor for the final evaluation of the 1-on-1 meeting. If the first user (supervisor) can appropriately control this, the engagement of the second user (subordinate) can be increased.

The information processing apparatus 1 according to the present embodiment is characterized by including the playback unit 45 that plays the comment audio in association with the evaluation item. This allows the user to objectively understand his or her behavior, and the satisfaction with the evaluation item is increased. This increases the effectiveness of assisting in enhancing communication skills useful in the 1-on-1 meetings.

The information processing apparatus 1 according to the present embodiment is characterized in that the playback unit 45 plays the voice of the comment of another user. The information processing apparatus 1 according to the present embodiment is characterized by playing an image synchronized with the comment in association with an evaluation item. This allows the user (first user) to objectively understand the interaction with the other user (second user who is a role of a subordinate) or the behavior of the user (first user).

The information processing apparatus 1 according to the present embodiment is characterized in that the playback unit 45 plays audio of a model comment prepared in advance for the evaluation item in association with the evaluation item. This allows the user (first user) to understand the difference between his or her behavior and a model example and objectively understand flows in his or her behavior.

The information processing apparatus 1 according to the present embodiment is characterized in that the display control unit 46 causes the display 408 to display a model comment prepared in advance for the evaluation item in association with the evaluation item. This allows the user (first user) to carefully read the model comment displayed in a static state and understand the model example at his or her own pace.

The information processing apparatus 1 according to the present embodiment is characterized by evaluating the comment of the user (first user) by determining the behavior of the other user (second user). In other words, the evaluation is made based on the reaction of the other user (second user) to the content of the comment of the user (first user). This increases the effectiveness of assisting in enhancing communication skills.

### Second Embodiment

An embodiment in which a subordinate role is replaced with a virtual character generated by an AI is described below. In the case of a virtual character generated by AI, a conversation can be made as per the scenario, and the behavior of the supervisor in a 1-on-1 meeting can be evaluated according to the standard. Accordingly, the evaluation accuracy of the evaluation item is increased. For example, when a subordinate role brings a consultation such as “I am struggling because the evaluation does not increase”, the facial expression and the tone of voice as the correct answer are roughly determined in advance as the behavior to be the model. Quantification of the difference from the model increases the accuracy of the evaluation.

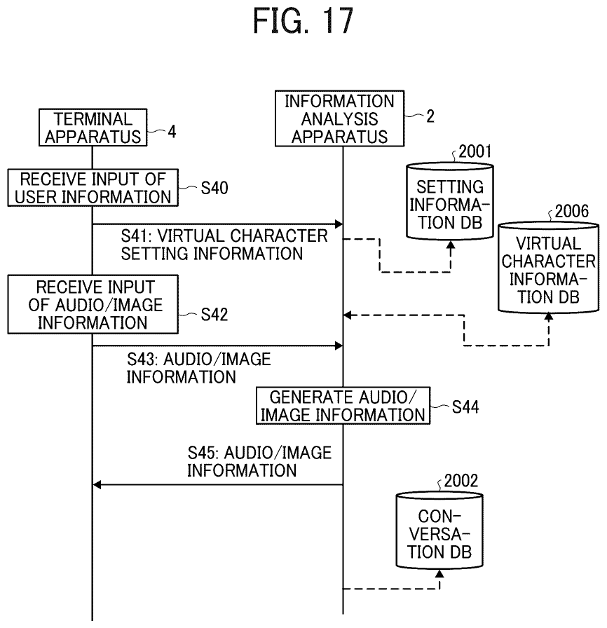

FIG. 17 is a sequence diagram illustrating a process when a virtual character is used. The input reception unit 44 receives input of user information (Step S40). A virtual character is set based on the user information, and the user information is virtual character setting information. The transmission/reception unit transmits the setting information to the information analysis apparatus 2 (Step S41). Then, the setting information is recorded in the setting information DB 2001. Information on the virtual character such as audio information, image information, and content of utterance is generated from the virtual character information DB 2006. The attribute of the virtual character, the personality model, the scenario pattern of the conversation, etc., may be selected by the supervisor.

When a question to the virtual character is input from the user terminal apparatus 4 (Step S42), the input audio/image information is transmitted to the information analysis apparatus 2 (Step S43). When the image/audio information of the user are input from the terminal apparatus 4, the information analysis apparatus 2 acquires the image/audio information of the user. The generation unit 24 analyzes information on the user's emotion based on the image/audio information and generates a response text to the user's question based on the result of the analysis on the information on the user's emotion and the character model of the virtual character (Step S44). The generation unit 24 generates response audio for playing an answer text with the voice of the virtual character. The response audio may be a stored audio information of a target person or an artificially generated audio. Further, the generation unit 24 generates a response image to be played when the response audio is played. The transmission/reception unit 27 transmits to the terminal apparatus 4 generated response audio and response image as a response video (Step S45). The response audio and the response image may be combined with each other as a data file to be transmitted to the terminal apparatus 4, or may transmitted to the terminal apparatus 4 as separate files. Then, the video of the virtual character is displayed on the terminal apparatus 4. That is, the virtual character answers the question from the user, and a conversation with the virtual character is established. This process may be repeated multiple times. This configuration allows the user to naturally interact with the virtual character. The conversation information is recorded in the conversation information DB 2002 in a file format. The behavior of the supervisor can be evaluated with high accuracy based on the stored information.

The information processing apparatus 1 according to the present embodiment is characterized by including a generation unit that generates a comment of a virtual character. With this configuration, responses to the comment of the virtual character can be easily standardized, and the behavior of the supervisor can be accurately evaluated. With the accurate and precise evaluation, the effectiveness of assisting in enhancing communication skills can be increased.

As described above, an example of aspects of the present disclosure is as follows.

### Aspect 1

The information processing apparatus 1 according to the present embodiment includes the display control unit 46 that causes the display 408 to display an evaluation item indicating an evaluation of a comment of a user in association with a character string of the comment. This allows the user to easily understand the comment and the evaluation item in association with each other, resulting in enhancing the satisfaction with the evaluation or the acceptance of the evaluation. This increases the effectiveness of assisting in enhancing communication skills.

### Aspect 2

The information processing apparatus 1 according to Aspect 1 includes the display control unit 46. The display control unit 46 displays the character strings of the comments and the evaluation items in chronological order.

The character strings of the comments arranged in chronological order allows the user to easily recall the behavior of the user. As a result, the satisfaction with the evaluation items or the acceptance of the evaluation items is increased. This increases the effectiveness of assisting in enhancing communication skills.

### Aspect 3

In the information processing apparatus 1 according to any one of Aspect 1 and Aspect 2, the display control unit 46 causes the display 408 to display character strings of comments of another user before and after the comment of the user. This allows the user to recall the interaction with the other user or the behavior of the user, and the satisfaction with the evaluation item or the acceptance of the evaluation items is increased. This increases the effectiveness of assisting in enhancing communication skills.

### Aspect 4

The information processing apparatus 1 of any one of Aspect 1 to Aspect 3 includes the evaluation unit 23 to evaluate the comment of the user and a training model including audio information and video information (stored in training model DB 2003). The evaluation unit 23 evaluates the comment of the user using the training model. The comment of the user can be accurately evaluated by comparison with the training model. In particular, in the case of a model of a virtual character whose role is a subordinate and created by generative AI, evaluation with precision can be achieved by a difference from the training model. Thus, highly accurate evaluation can be achieved.

### Aspect 5

In the information processing apparatus 1 of any one of Aspect 1 to Aspect 4, the evaluation item includes an intermediate evaluation item that is not displayed on the display (hidden from the display). Since there are many evaluation viewpoints by the intermediate evaluation items, accurate evaluation can be achieved. Depending on the user, the intermediate evaluation item does not function as the evaluation item. One or more of the intermediate evaluation items that effectively assist the user may be displayed by narrowing down them without displaying all the evaluated items.

### Aspect 6

In the information processing apparatus 1 of any one of Aspect 1 to Aspect 5, the evaluation item includes at least one of an acknowledgement skill, a listening skill, and a questioning skill that are items related to an interactive communication skill. Thus, the communication in a 1-on-1 meeting can be evaluated for each item, thereby increasing the effectiveness of assisting in enhancing communication skills useful for the 1-on-1 meetings.

### Aspect 7

In the information processing apparatus 1 of any one of Aspect 1 to Aspect 5, the evaluation item includes at least one of a facial expression, a tone of voice, and a gesture that are items related to an impression from the user. This allows the user who has a role of a supervisor to improve his or her behavior to give better impression to the other user such as the subordinate, thereby increasing the effectiveness of assisting in enhancing communication skills useful for the 1-on-1 meetings.

### Aspect 8

The information processing apparatus 1 according to any one of Aspect 1 to Aspect 7 includes the display control unit 46. The display control unit 46 causes the display 408 to display an evaluation indicator of the evaluation item in association with the evaluation item. This allows the user to accurately understand his or her behavior for the evaluation item. This increases the effectiveness of assisting in enhancing communication skills useful in the 1-on-1 meetings.

### Aspect 9

The information processing apparatus 1 according to any one of Aspect 1 to Aspect 8 includes the playback unit 45 that plays audio of the comment or an image including the audio in association with the evaluation item. This allows the user to objectively understand his or her behavior for the evaluation item. This increases the effectiveness of assisting in enhancing communication skills useful in the 1-on-1 meetings.

### Aspect 10

The information processing apparatus 1 according to any one of Aspect 1 to Aspect 9 includes the playback unit 45 that plays additional audio of an additional comment of the other user or an image including the additional audio. This allows the user to objectively understand the interaction with the other user who is a role of a subordinate or the behavior of the user, and the satisfaction with the evaluation item is increased. This increases the effectiveness of assisting in enhancing communication skills.

### Aspect 11

In the information processing apparatus 1 according to any one of Aspect 1 to Aspect 10, the playback unit 45 plays still additional audio of a model comment prepared in advance for the evaluation item or an image including the still additional in association with the evaluation item. This allows the user to understand the difference between his or her behavior and a model example and objectively understand flows in his or her behavior, and the satisfaction with the evaluation item is increased. This increases the effectiveness of assisting in enhancing communication skills useful in the 1-on-1 meetings.

### Aspect 12

In the information processing apparatus 1 according to any one of Aspect 1 to Aspect 11, the display control unit 46 causes the display 408 to display a model comment prepared in advance for the evaluation item in association with the evaluation item. This allows the user (first user) to carefully read the model comment displayed in a static state and understand a model example at his or her own pace. This allows the user to understand the difference between his or her behavior and the model example and objectively understand flows in his or her behavior, and the satisfaction with the evaluation item is increased. This increases the effectiveness of assisting in enhancing communication skills useful in the 1-on-1 meetings.

### Aspect 13

The information processing apparatus 1 according to the present embodiment includes the generation unit 24 that generates a display screen to be displayed on the display 408. The display screen includes an evaluation item indicating an evaluation of a comment of a user in association with a character string of the comment. This allows the user to easily understand the comment and the evaluation item in association with each other, resulting in enhancing the satisfaction with the evaluation or the acceptance of the evaluation. This increases the effectiveness of assisting in enhancing communication skills.

### Aspect 14

A program according to the present embodiment cause a display to display an evaluation item indicating an evaluation of a comment of a user in association with a character string of the comment. This allows the user to easily understand the comment and the evaluation item in association with each other, resulting in enhancing the satisfaction with the evaluation or the acceptance of the evaluation. This increases the effectiveness of assisting in enhancing communication skills.

### Aspect 15

The information processing apparatus 1 according to any one of Aspect 1 to Aspect 14 evaluates the comment of the user by determining the behavior of the other user.

In other words, the evaluation is made based on the reaction of the other user (second user) to the content of the comment of the user (first user). This increases the effectiveness of assisting in enhancing communication skills.

### Aspect 16

The information processing apparatus 1 according to any one of Aspect 1 to Aspect 15 includes an authentication system to identify the user. This ensures security and eliminates concerns about being viewed by an unspecified number of individuals. This increases the effectiveness of assisting in enhancing communication skills.

### Aspect 17

The information processing apparatus 1 according to any one of Aspect 1 to Aspect 16 displays the advice 520 for the result of the evaluation item. This increases the effectiveness of assisting in enhancing communication skills.

### Aspect 18

The information processing apparatus 1 according to any one of Aspect 1 to Aspect 17 includes a generation unit that generates a comment of a virtual character. With this configuration, a response to the comment of the virtual character can be easily standardized, and the behavior of the supervisor can be accurately evaluated. With the accurate and precise evaluation, the effectiveness of assisting in enhancing communication skills can be increased. According to one or more aspects, an information processing apparatus with highly effective assistance for enhancing communication skills can be provided.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus, comprising circuitry configured to:
display, on a display, an evaluation item indicating an evaluation of a comment of a user in association with a character string of the comment.

2. The information processing apparatus of claim 1, wherein
the evaluation item includes a plurality of evaluation items,
the character string of the comment includes a plurality of character strings of a plurality of comments, and
the circuitry displays, on the display, the plurality of evaluation items and the plurality of character strings of the plurality of comments in chronological order.

3. The information processing apparatus of claim 1, wherein
the circuitry is configured to display, on the display, additional character strings of additional comments of another user, one or more of the additional character strings of said another user being displayed before and after the comment of the user.

4. The information processing apparatus of claim 1, further comprising:
a memory that stores a training model including audio information and video information, wherein
the circuitry is further configured to evaluate the comment of the user using the training model.

5. The information processing apparatus of claim 1, wherein
the evaluation item includes an intermediate evaluation item that is hidden from the display.

6. The information processing apparatus of claim 1, wherein
the evaluation item includes at least one of an acknowledgement skill, a listening skill, or a questioning skill that is related to an interactive communication skill.

7. The information processing apparatus of claim 1, wherein
the evaluation item includes at least one of a facial expression, a tone of voice, or a gesture that is related to an impression from the user.

8. The information processing apparatus of claim 1, wherein
the circuitry is configured to display, on the display, an evaluation indicator for the evaluation item in association with the evaluation item.

9. The information processing apparatus of claim 1, wherein
the circuitry is further configured to play one of audio of the comment and an image including the audio in association with the evaluation item.

10. The information processing apparatus of claim 9, wherein
the circuitry is configured to play one of audio of an additional comment of another user and an additional image including the audio of the additional comment.

11. The information processing apparatus of claim 9, wherein
the circuitry is configured to play one of audio of a model comment prepared in advance for the evaluation item or an image including the audio of the model comment in association with the evaluation item.

12. The information processing apparatus of claim 1, wherein
the circuitry is configured to display, on the display, a model comment prepared in advance for the evaluation item in association with the evaluation item.

13. An information processing apparatus comprising circuitry configured to:
generate a display screen to be displayed on a display, the display screen including an evaluation item indicating an evaluation of a comment of a user in association with a character string of the comment.

14. A non-transitory recording medium storing a plurality of instructions which, when executed by one or more processors, causes the processors to perform a method, the method comprising:
displaying, on a display, an evaluation item indicating an evaluation of a comment of a user in association with a character string of the comment.
